(19) United States
(12) Patent Application Publication
(10) Pub. No.: US 2015/0061349 A1
(43) Pub. Date: Mar. 5, 2015

(54) LOCKING UNIT FOR A VEHICLE SEAT

(71) Applicant: Johnson Controls GmbH, Burscheid (DE)

(72) Inventor: Patrick Handl, Koln (DE)

(21) Appl. No.: 14/395,142

(22) PCT Filed: May 17, 2013
(86) PCT No.: PCT/EP2013/060236

§ 371 Date: Oct. 17, 2014

(30) Foreign Application Priority Data
Jun. 1, 2012 (DE) 10 2012 011 515.6

(51) Int. Cl. B60N 2/015; B60N 2/22

(52) U.S. Cl. CPC B60N 2/01583; B60N 2/2245
USPC 297/463.1; 403/322.4

(57) ABSTRACT

A locking unit (10) for a vehicle seat (1) includes a pivotally mounted rotary latch (20) for locking to a bolt (12). The rotary latch (20) includes a rotary latch hole (24) for pivotably mounting on a bearing pin (51) which protrudes through the rotary latch hole (24). A detent (30) secures the locking unit (10) in the locked state in the event of a crash. The rotary latch (20) supports itself on a first contact point against the detent (30). The rotary latch (20) includes at least one recess area (25) which enables the rotary latch (20) to deform in the event of a crash. The recess area (25) is arranged at a distance from the rotary latch hole (24) in the radial direction.

### CROSS REFERENCE TO RELATED APPLICATIONS

This application is a United States National Phase Application of International Application PCT/EP2013/060236 filed May 17, 2013 and claims the benefit of priority under 35 U.S.C. §119 of German Patent Application DE 10 2012 011 515.6 filed Jun. 1, 2012, the entire contents of which are incorporated herein by reference.

### FIELD OF THE INVENTION

The invention relates to a locking unit for a vehicle seat with a pivotably mounted rotary latch for locking with a bolt, the rotary latch having a rotary latch hole for pivotably mounting on a bearing bolt protruding through the rotary latch hole, and a latching pawl which, in the event of a crash, secures a locked state of the locking unit by the rotary latch being supported on a first contact point on the latching pawl. The invention also relates to a vehicle seat with the locking unit.

### BACKGROUND OF THE INVENTION

DE 10 2008 051 832 A1 discloses a locking unit of the type in question for a vehicle seat. A locking unit of this type comprises a pivotably mounted rotary latch for locking with a bolt. A latching pawl which is mounted pivotably about another pivot axis secures the rotary latch in the locked state. A tensioning element which is referred to as a tolerance-compensating pawl exerts a closing moment on the rotary latch and thereby eliminates play present between the rotary latch and the bolt.

DE 20 2011 100 040 U1 likewise discloses a locking unit for a vehicle seat. The rotary latch of this locking unit has a recess which differs from the circular shape and is approximately in the shape of an elongated hole and by means of which said rotary latch is mounted pivotably on a bush or a bearing bolt.

The latching pawl and the tensioning element are arranged so as to be pivotable about the same axis and axially offset next to each other on a bearing bolt and interact with the rotary latch. In the event of a crash, first of all only the latching pawl secures the rotary latch by the rotary latch being supported on a contact point on the latching pawl. The crash load which is transmitted by the bolt to the rotary latch in the event of a crash is absorbed here by the contact point of the rotary latch with the latching pawl.

In the event of a high crash load, the rotary latch is displaced relative to the bearing bolt along the recess which is approximately in the shape of an elongated hole until it comes to bear against the housing of the locking unit. This gives rise to a second contact point which can additionally absorb the crash load.

### SUMMARY OF THE INVENTION

The invention is based on an object of improving a locking unit of the type mentioned at the beginning, in particular of specifying an alternative possibility for increasing the load-absorption capacity in the event of a crash, in order to increase the crash safety of a vehicle seat.

A locking unit of the type in question for a vehicle seat comprises a pivotably mounted rotary latch for locking with a bolt, wherein the rotary latch has a rotary latch hole for pivotably mounting on a bearing bolt protruding through the rotary latch hole, and a latching pawl which, in the event of a crash, secures a locked state of the locking unit by the rotary latch being supported on a contact point on the latching pawl.

According to the invention, it is provided that the rotary latch of the locking unit has at least one cutout region which, in the event of a crash, permits a deformation of the rotary latch, wherein the cutout region is arranged spaced apart in the radial direction from the rotary latch hole. The cutout region is therefore formed separately from the rotary latch hole and is separated therefrom, for example, by a web.

Owing to the fact that the rotary latch has a cutout region which, in the event of a crash, permits a deformation, and which is arranged spaced apart in the radial direction from the rotary latch hole, the rotary latch can be displaced in the event of a crash until said rotary latch comes to bear against the housing of the locking unit, thus producing a second contact point which can additionally absorb the crash load.

Owing to the deformation in the event of a crash, the rotary latch advantageously executes a displacement of this type, i.e. a translatory movement and/or a tilting movement, in order to reach the housing.

According to an advantageous refinement, the cutout region is designed as a continuous opening in the axial direction. A cutout region designed in such a manner can be produced relatively simply, for example, by means of punching.

According to an alternative refinement, the cutout region is designed as a notch.

The rotary latch advantageously has a hook mouth for receiving the bolt.

It is particularly advantageous here if the cutout region is arranged on that side of the rotary latch hole which faces away from the hook mouth.

According to an advantageous development of the invention, the rotary latch has at least one load-relieving region which is provided on that side of the rotary latch hole which is opposite the cutout region. The load-relieving region assists the deformation of the rotary latch.

If, in the locked state, a tensioning element exerts a closing moment on the rotary latch, a play present between the rotary latch and the bolt can thereby be eliminated.

According to an advantageous refinement of the invention, the rotary latch and the latching pawl are arranged within an at least partially closed housing.

The cutout region preferably runs approximately in a semicircle around the rotary latch hole.

The object is also achieved by a vehicle seat comprising at least one locking unit according to the invention.

The invention is explained in more detail below with reference to an advantageous exemplary embodiment illustrated in the drawings. However, the invention is not restricted to said exemplary embodiment.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an exploded illustration of a locking unit;

FIG. 2 is a schematized illustration of a vehicle seat;

FIG. 3 is a top view of parts of the locking unit according to a first exemplary embodiment in the locked state;

FIG. 4 is a top view of parts of the locking unit according to the first exemplary embodiment in the event of a crash; and

FIG. 5 is a top view of parts of the locking unit according to a second exemplary embodiment in the locked state.

### DESCRIPTION OF THE PREFERRED EMBODIMENTS

Referring to the drawings in particular, in a motor vehicle, a locking unit 10 for connecting a backrest 3 of a vehicle seat 1, in particular a rear seat, to a vehicle structure is provided. The backrest 3 here is attached to a seat part 5 so as to be pivotable from a use position into a not-in-use position.

However, the locking unit 10 can also be used at different locations, for example for fastening the seat part 5 of the vehicle seat 1 to the floor structure of the motor vehicle, or in a door lock.

The arrangement of the vehicle seat 1 within the vehicle and the customary direction of travel thereof define the directional details used below. A direction oriented perpendicularly to the ground is referred to below as the vertical direction and a direction perpendicular to the vertical direction and perpendicular to the direction of travel is referred to below as the transverse direction.

The locking unit 10 has a lock housing which comprises a first side plate 16 and a second side plate 18. In the present case, the basic surfaces of the side plates 16, 18 are of flat configuration and are arranged in a plane defined by the direction of travel and the vertical direction, i.e. perpendicularly to the transverse direction. Each of the side plates 16, 18 comprises two bearing bores 13 which, in the present case, are of circular design.

The first side plate 16 and the second side plate 18 form a receptacle which opens in the direction of a bolt 12 in order to receive the latter for locking purposes. The locking unit 10 in the present case is fastened to the backrest 3 and the bolt 12 is fastened to the vehicle structure. It is also conceivable for the locking unit 10 to be fastened to the vehicle structure and for the bolt 12 to be fastened to the backrest 3. That portion of the bolt 12 which is to be received by the receptacle generally runs horizontally in the transverse direction.

A rotary latch 20 is mounted pivotably on a first bearing bolt 51 which, in turn, is fastened to the first side plate 16 and to the second side plate 18. For this purpose, the rotary latch 20 has a rotary latch hole 24 through which the first bearing bolt 51 protrudes. The rotary latch 20 furthermore has a hook mouth 21 for interaction with the bolt 12. The rotary latch 20 is pretensioned in the opening direction by means of a first spring 71.

The rotary latch 20 has a functional surface 22 which partially laterally bounds the hook mouth 21. In the locked state, the functional surface 22 approximately faces in the direction of a second bearing bolt 52 which is arranged parallel to the first bearing bolt 51 and therefore likewise runs in the transverse direction. In the present case, the functional surface 22 is of planar design, but can also be, for example, curved in the shape of an arc of a circle and of concave design.

On that side of the hook mouth 21 which faces away from the rotary latch hole 24 and is opposite the functional surface 22, the hook mouth 21 is bounded laterally by a lug 28 of the rotary latch 20.

The rotary latch 20 has a basic body which is bounded in the axial direction by a flat basic surface in each case. The width of the functional surface 22 corresponds to the thickness of the basic body of the rotary latch 20, i.e. to the extent of the basic body in the axial direction.

The first bearing bolt 51 is inserted into respective bearing bores 13 in the side plates 16, 18 and protrudes perpendicularly from the basic surfaces of the side plates 16, 18. The first bearing bolt 51 therefore runs horizontally in the transverse direction. In the present case, the preferably metallic first bearing bolt 51 is riveted or calked to the side plates 16, 18. The first bearing bolt 51 is preferably designed in the form of a hollow cylinder in order to receive a fastening means, for example a screw, by means of which the locking unit 10 is fastened to the backrest 3 during the installation.

The second bearing bolt 52 is also inserted into respective bearing bores 13 in the side plates 16, 18 and protrudes perpendicularly from the basic surfaces of the side plates 16, 18. The second bearing bolt 52 therefore likewise runs horizontally in the transverse direction. In the present case, the preferably metallic second bearing bolt 52 is riveted or calked to the side plates 16, 18. In the same manner as the first bearing bolt 51, the second bearing bolt 52 is preferably designed in the form of a hollow cylinder in order to receive a fastening means, for example a screw, by means of which the locking unit 10 is fastened to the backrest 3 during the installation.

A tensioning element 40 is mounted pivotably on the second bearing bolt 52. For this purpose, the tensioning element 40 has a tensioning element hole 44 which, in the present case, is circular and is penetrated by the second bearing bolt 52. The tensioning element 40 is pretensioned toward the rotary latch 20 by means of a third spring 73.

In the locked state, when the hook mouth 21 of the rotary latch 20 receives the bolt 12, the tensioning element 40 exerts a closing moment on the rotary latch 20 owing to the pretensioning by the third spring 73 as a securing element. For this purpose, the tensioning element 40 has a tensioning surface 41 which is curved eccentrically with respect to the second bearing bolt 52 and is in non-self-locking contact with the functional surface 22 of the rotary latch 20. In the present case, the tensioning surface 41 is curved in the shape of an arc of a circle and is of convex design.

A latching pawl 30 is arranged on the second bearing bolt 52 axially next to the tensioning element 40 and is likewise mounted pivotably on the second bearing bolt 52, i.e. in alignment with the tensioning element 40. For this purpose, the latching pawl 30 has a latching pawl hole 34 which, in the present case, is circular and is penetrated by the second bearing bolt 52. The latching pawl 30 is pretensioned toward the rotary latch 20 by means of a second spring 72.

In the present case, the latching pawl 30 is arranged adjacent to the first side plate 16 and, in the present case, the tensioning element 40 is arranged adjacent to the second side plate 18. The latching pawl 30 and the tensioning element 40 are coupled by empty travel for carrying-along purposes, for example by means of a slot and pin guide or by means of an axially protruding driver.

The latching pawl 30 has a latching surface 31 which is in the vicinity of the tensioning surface 41 of the tensioning element 40. In the locked state, the latching surface 31 is positioned spaced apart from the functional surface 22 of the rotary latch 20. In the present case, the latching surface 31 is curved in the shape of an arc of a circle and is of convex design, but may also be planar.

The width of the functional surface 22, which corresponds to the thickness of the basic body of the rotary latch 20, also approximately corresponds to the total of the thickness of the latching pawl 30 and the thickness of the tensioning element 40. The rotary latch 20 therefore has approximately the same material thickness as the latching pawl 30 and the tensioning element 25 together.

According to a first exemplary embodiment, the rotary latch 20 has a cutout region 25 on that side of the rotary latch hole 24 which faces away from the hook mouth 21. In the present case, the cutout region 25 is designed as a continuous opening in the axial direction and runs approximately in a semicircle around the rotary latch hole 24. The cutout region 25 therefore completely penetrates the basic body of the rotary latch 20 in the axial direction, parallel to the rotary latch hole 24 which, in the present case, is designed as a circular bore.

The cutout region 25 here is arranged spaced apart in the radial direction from the rotary latch hole 24. The cutout region 25 is therefore formed separately from the rotary latch hole 24 and, in the present case, is separated therefrom by a web. The cutout region 25 therefore does not have any connection with the rotary latch hole 24.

However, the cutout region 25 may also be designed in a different manner. For example, the cutout region 25 can be designed as a notch which extends from the surface of the basic body of the rotary latch 20 into the basic body, but not through the latter. The semicircular cutout region 25 can also be interrupted by one or more webs. Furthermore, the cutout region 25 can have a design differing from the semicircular shape, for example a rectangular, circular or oval shape. Similarly, a plurality of rectangular, circular, oval or differently designed cutout regions 25 can be provided next to one another and/or separated from one another by webs.

In the present case, two load-relieving regions 27 are provided on that side of the rotary latch hole 24 which is opposite the cutout region 25. The load-relieving regions 27 are therefore arranged approximately between the rotary latch hole 24 and the hook mouth 21 of the rotary latch 20. In the present case, the load-relieving regions 27 are formed in the shape of a segment of a circle and are separated from one another by a web running in the radial direction. In the present case, the load-relieving regions 27 are likewise designed as a continuous opening in the axial direction and completely penetrate the basic body of the rotary latch 20 in the axial direction, parallel to the rotary latch hole 24.

The load-relieving regions 27 can also be designed so as to differ from the shape shown here, for example can be designed as a notch or with a different design, in a similar manner to the cutout region. It is also conceivable for only one load-relieving region 27 to be provided or for the latter also to be entirely omitted.

According to a second exemplary embodiment, which is illustrated in FIG. 5, there is no load-relieving region.

FIG. 3 illustrates the positions of the rotary latch 20 and the latching pawl 30 of the locking unit 10 according to the first exemplary embodiment in the locked state.

The bolt 12 bears against the lug 28 of the rotary latch 20 in the hook mouth 21. In the event of a crash, the rotary latch 20 experiences an opening moment by means of the bolt 12 and pushes the tensioning element 40 (not illustrated here) away. As a result, the latching surface 31 of the latching pawl 30 first of all enters into contact with the functional surface 22 of the rotary latch 20. The latching pawl 30 thus serves to support the rotary latch 20 and, as a securing element, prevents a further rotation of the rotary latch 20 in the opening direction. The latching pawl 30 therefore prevents the rotary latch 20 from opening.

If, on account of the crash, the bolt 12 exerts a further load on the lug 28 of the rotary latch 20, the rotary latch 20 undergoes a translatory movement approximately in the loading direction. In the process, the bearing bolt 51 (not illustrated in FIG. 3), on the side facing away from the hook mouth 21 presses against the wall of the rotary latch hole 24. In the process, the cutout region 25 of the rotary latch 20 is compressed and the rotary latch 20 is deformed. The rotary latch 20 migrates here in the loading direction mentioned.

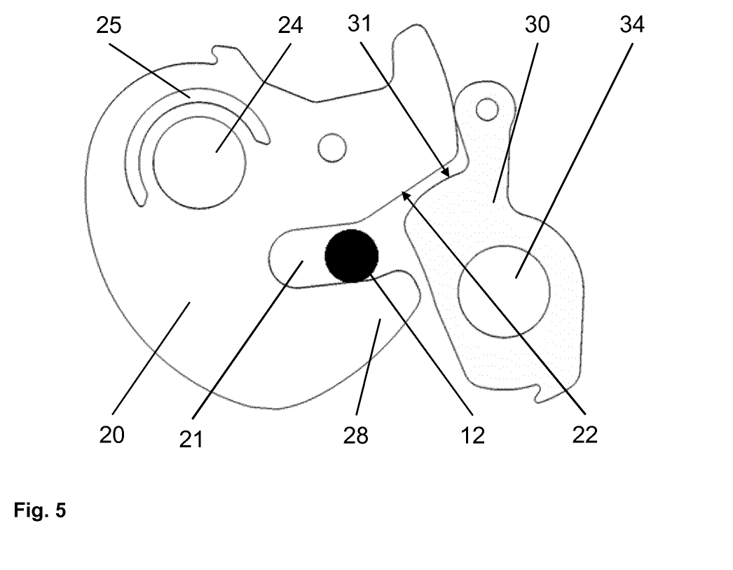

The movement of the rotary latch 20 in the loading direction ends when the rotary latch 20 enters into contact with one of the housing parts 16, 18 or when the rotary latch has covered a distance which corresponds to the radial extent of the cutout region 25. This position is illustrated in FIG. 4.

During the movement described here of the rotary latch 20, the load-relieving regions 27 also assist the deformation of the rotary latch 20. The load-relieving regions 27 are expanded here, as a result of which the radial extent thereof is increased. The material of the rotary latch 20 in the region between the load-relieving regions 27 and the rotary latch hole 24 can also tear off in the process, as can the web between the load-relieving regions 27.

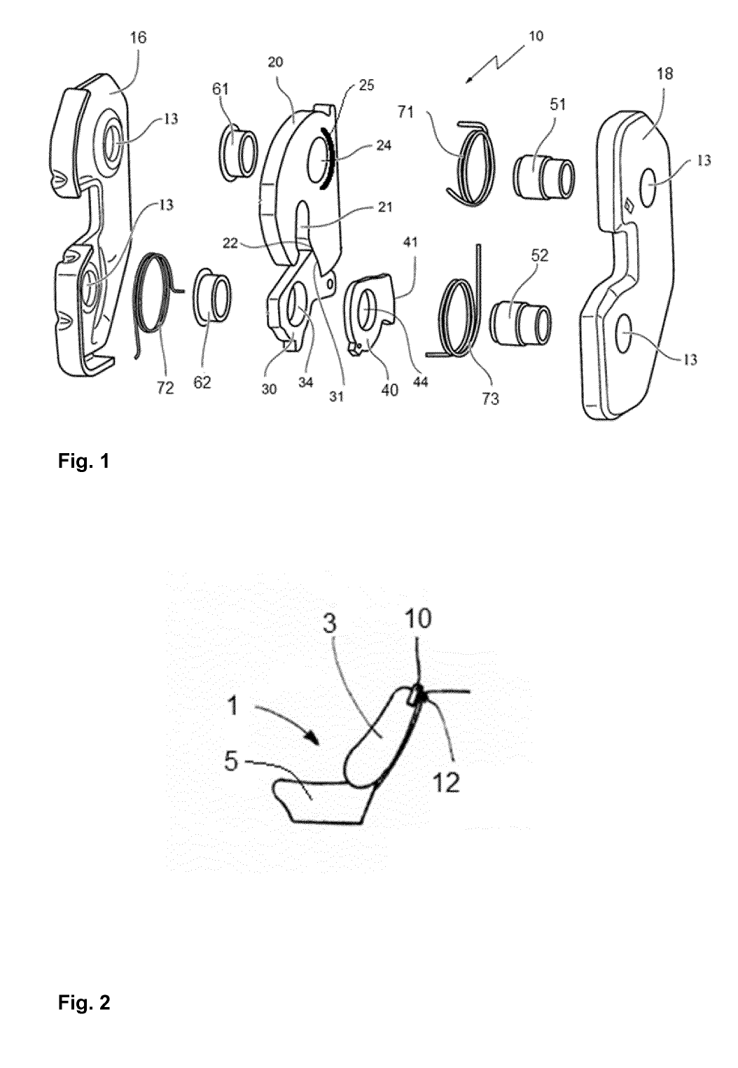

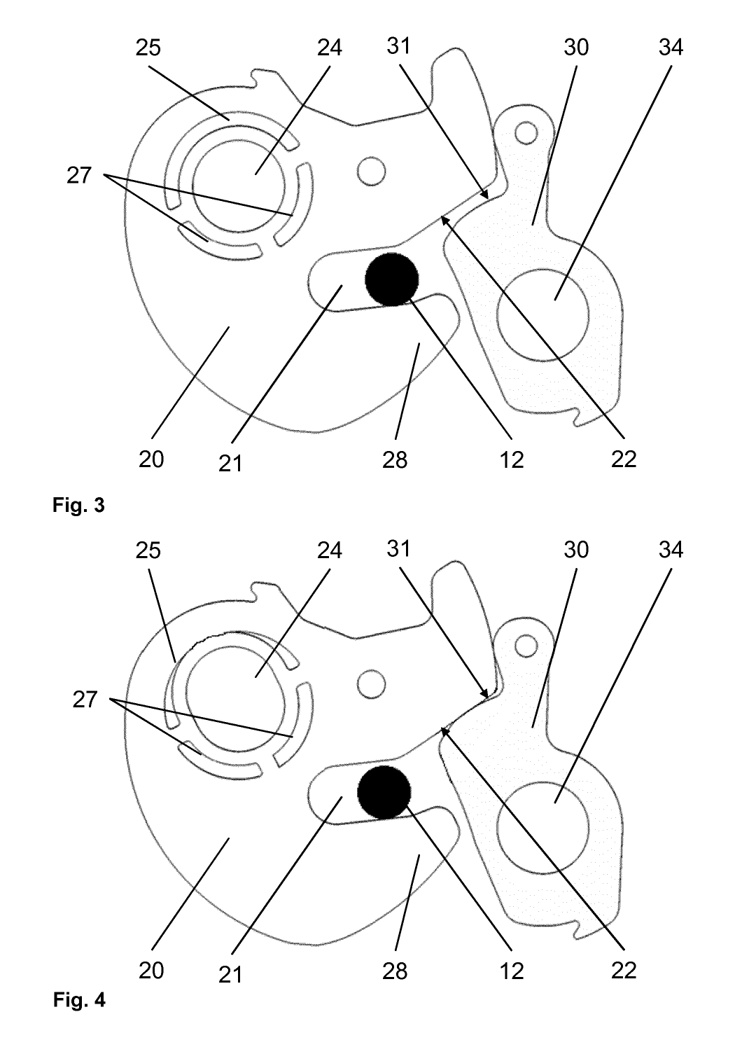

In all of the exemplary embodiments described here, the first bearing bolt 51, as illustrated in FIG. 1, is encased by a first slide bush 61. The first slide bush 61 is also designed in the form of a hollow cylinder. The first slide bush 61 is therefore located in the radial direction between the first bearing bolt 51 and the rotary latch 20.

As illustrated in FIG. 1, the second bearing bolt 52 is encased by a second slide bush 62. The second slide bush 62 is also designed in the form of a hollow cylinder. The second slide bush 62 is therefore located in the radial direction between the first bearing bolt 51 and the latching pawl 30 and also the tensioning element 40.

The first sliding bush 61 and the second sliding bush 62 can also be omitted or formed integrally with the first bearing bolt 51 and the second bearing bolt 52.

In the locked state of the locking unit 10, the bolt 12 is located in the receptacle formed by the side plates 16, 18 and in the hook mouth 21 of the closed rotary latch 20. The tensioning element 40 secures the rotary latch 20 by interaction of the tensioning surface 41 with the cam 26. The latching surface 31 of the latching pawl 30 is slightly spaced apart from the functional surface 22 of the rotary latch 20.

In order to open the locking unit 10, the latching pawl 30 is pivoted away from the rotary latch 20, as a result of which the latching surface 31 of the latching pawl 30 is further away from the functional surface 22 of the rotary latch 20. The latching pawl 30 carries along the tensioning element 40 owing to the carrying-along coupling, and therefore the rotary latch 20 is no longer secured.

By means of the pretensioning on account of the first spring 71, the rotary latch 20 opens, i.e. pivots in the opening direction. Alternatively or in addition to the pretensioning by the first spring 71, the rotary latch 20 can also be carried along for opening purposes by the latching pawl 30 or by the tensioning element 40.

Owing to the pivoting movement of the rotary latch 20, the hook mouth 21 draws back from the receptacle formed by the side plates 16, 18 and releases the bolt 12 which moves away from the locking unit 10 counter to the pivoting-in direction. If the bolt 12 has left the hook mouth 12, the locking unit 10 is in the unlocked state.

If, in said unlocked state, the bolt 12 passes again into the receptacle formed by the side plates 16, 18 and enters into contact with the border of the hook mouth 21, the bolt 12 pushes the rotary latch 20 into the closed position thereof. The tensioning element 40, owing to the pretensioning thereof by the third spring 73, moves along the cam 26. Carried along by the tensioning element 40 or owing to the pretensioning by the second spring 72, the latching pawl 30 pivots toward the rotary latch 20, with the latching surface 31 approaching the functional surface 22 of the rotary latch 20. The locking unit 10 is then in the locked state again.

The features disclosed in the above description, the claims and the drawings can be of importance both individually and in combination for realizing the invention in the various configurations thereof.

While specific embodiments of the invention have been shown and described in detail to illustrate the application of the principles of the invention, it will be understood that the invention may be embodied otherwise without departing from such principles.

1-11. (canceled)

12. A locking unit for a vehicle seat, the locking unit comprising:
a pivotably mounted rotary latch for locking with a bolt, the rotary latch having a rotary latch hole for pivotably mounting on a bearing bolt protruding through the rotary latch hole; and
a latching pawl securing the locking unit in a locked state in the event of a crash, the rotary latch being supported on a first contact point on the latching pawl, wherein the rotary latch has at least one cutout region which, in the event of a crash, permits a deformation of the rotary latch, wherein the cutout region is arranged spaced apart from the rotary latch hole in a radial direction.

13. A locking unit as claimed in claim 12, wherein upon the deformation in the event of a crash, the rotary latch executes at least one of a translatory movement and a tilting movement.

14. A locking unit as claimed in claim 12, wherein the cutout region is designed as a continuous opening in an axial direction.

15. A locking unit as claimed in claim 12, wherein the cutout region is designed as a notch.

16. A locking unit as claimed in claim 12, wherein the rotary latch has a hook mouth for receiving the bolt.

17. A locking unit as claimed in claim 16, wherein the cutout region is arranged on a side of the rotary latch hole that faces away from the hook mouth.

18. A locking unit as claimed in claim 17, wherein at least one load-relieving region is provided on that side of the rotary latch hole which is opposite the cutout region.

19. A locking unit as claimed in claim 12, further comprising a tensioning element, wherein in the locked state the tensioning element exerts a closing moment on the rotary latch.

20. A locking unit as claimed in claim 12, wherein the rotary latch and the latching pawl are arranged within an at least partially closed housing.

21. A locking unit as claimed in claim 12, wherein the cutout region runs approximately in a semicircle around the rotary latch hole.

22. A vehicle seat comprising at least one locking unit comprising:
a pivotably mounted rotary latch for locking with a bolt, the rotary latch having a rotary latch hole for pivotably mounting on a bearing bolt protruding through the rotary latch hole; and
a latching pawl securing the locking unit in a locked state in the event of a crash, the rotary latch being supported on a first contact point on the latching pawl, wherein the rotary latch has at least one cutout region which, in the event of a crash, permits a deformation of the rotary latch, wherein the cutout region is arranged spaced apart from the rotary latch hole in a radial direction.

23. A locking unit for a vehicle seat, the locking unit comprising:
a pivotably mounted rotary latch for locking with a bolt, the rotary latch having a rotary latch hole for pivotably mounting on a bearing bolt protruding through the rotary latch hole, the rotary latch defining at least one cutout region with an adjacent deformable portion, which deforms in the event of a crash, wherein the cutout region is arranged spaced apart from the rotary latch hole in a radial direction; and
latching pawl securing the locking unit in a locked state in the event of a crash, the rotary latch being supported on a first contact point on the latching pawl.

24. A locking unit as claimed in claim 23, wherein upon the deformation in the event of a crash, the rotary latch executes at least one of a translatory movement and a tilting movement.

25. A locking unit as claimed in claim 23, wherein the cutout region comprises a continuous opening in an axial direction.

26. A locking unit as claimed in claim 23, wherein the cutout region comprises a notch.

27. A locking unit as claimed in claim 23, wherein the rotary latch comprises a hook mouth for receiving the bolt.

28. A locking unit as claimed in claim 27, wherein the cutout region is arranged on a side of the rotary latch hole that faces away from the hook mouth.

29. A locking unit as claimed in claim 28, wherein at least one load-relieving region is provided on that side of the rotary latch hole which is opposite the cutout region.

30. A locking unit as claimed in claim 23, further comprising a tensioning element, wherein in the locked state the tensioning element exerts a closing moment on the rotary latch.

31. A locking unit as claimed in claim 23, wherein the cutout region runs approximately in a semicircle around the rotary latch hole.
